(19) United States
(12) Patent Application Publication
(10) Pub. No.: US 2010/0033019 A1
(43) Pub. Date: Feb. 11, 2010

(54) MODULAR SOLAR DEVICE POWER DISTRIBUTION

(75) Inventors: Mark Connell, Albuquerque, NM (US); Steve Hays, Albuquerque, NM (US); Mohammad Ghassemi, Las Cruces, NM (US)

Correspondence Address: SCHWEGMAN, LUNDBERG & WOESSNER, P.A., P.O. BOX 2938, MINNEAPOLIS, MN, 55402, US

(73) Assignee: Noribachi LLC, Albuquerque, NM (US)

(21) Appl. No.: 12/533,287

(22) Filed: Jul. 31, 2009

Related U.S. Application Data
(60) Provisional application No. 61/086,738, filed on Aug. 6, 2008.

(51) Int. Cl. H02J 1/10

(52) U.S. Cl. 307/82

(57) ABSTRACT

A system includes a power distributor having a power collection rail and a power management rail disposed within a track. A first module having a solar collector is adapted to couple to the track and electrically connect to the power collection rail. A rechargeable battery provides direct current (DC) power to the power management rail. A controller is coupled the battery and to the track to receive power from the power collection rail to recharge the battery. Various modules having solar collectors, batteries and devices may be coupled to the track.

### RELATED APPLICATIONS

This patent application claims the benefit of priority, under 35 U.S.C. §119(e), to U.S. Provisional Patent Application Ser. No. 61/086,738, filed on Aug. 6, 2008, which is incorporated herein by reference in its entirety.

### BACKGROUND

Solar panels are widely used today for collecting solar power. Some solar power systems contain an inverter that converts a direct current (DC) voltage from the solar cells making up the solar panels to an alternating current (AC) voltage, which is then coupled to a power distribution grid. Homes and businesses with such solar panel and inverter combinations provide some of their own power, with excess power being sold back to a power utility through the power grid.

Many further applications for solar panels involves their use with lower power DC devices, such as outdoor lighting, road side signs, calculators, sensors and many other devices that are wired to the solar panels. Such uses may or may not include an inverter depending on the power needs of the devices.

### BRIEF DESCRIPTION OF THE DRAWINGS

FIG. 1 is a block schematic diagram of a solar power collection and distribution system according to an example embodiment.

FIG. 2 is a block schematic diagram representation of a module for attachment to the distribution system of FIG. 1.

FIG. 3 is a photograph of example modules plugged into a power distribution track according to an example embodiment.

FIGS. 4A, 4B, 4C and 4D are schematic representations of connection to a power distribution track according to an example embodiment.

FIGS. 5A, 5B, and 5C are alternative schematic representation so of connection to a power distribution track according to an example embodiment.

FIG. 6 is a block diagram representation of a connector and power distribution track combination for providing physical support for a module according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

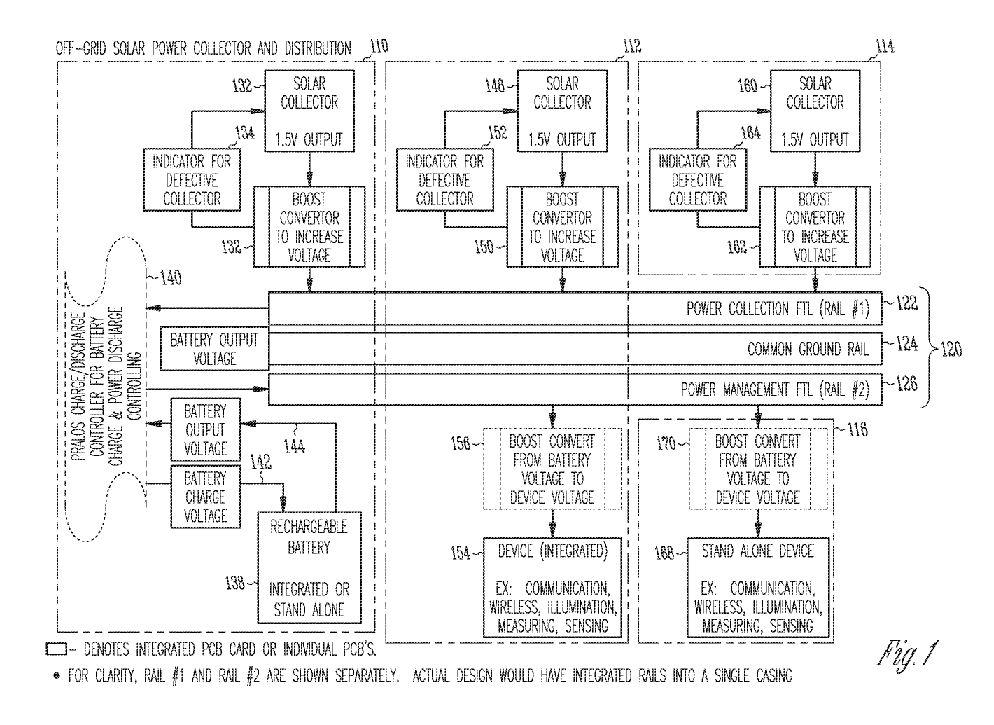

FIG. 1 is a block schematic diagram of a solar power collection and distribution system 100 according to an example embodiment. In one embodiment, the system 100 includes one or more modules as indicated by broken lines at 110, 112, 114 and 116. Each of the modules is electrically coupled to selected portions of a power distributor 120. In one embodiment, the power distributor 120 includes three different conductive rails as indicated at power collection rail 122, common ground rail 124 and power management rail 126. In further embodiments, the power collection and power management rails may be combined into a single rail.

Module 110 in one embodiment includes a solar collector 130, that is electrically coupled to the power collection rail 122 to provide current to the power collection rail 122 for collection. The voltage of the current provided by solar collector 130 may be boosted to a desired level by a boost converter 132. In one embodiment, the solar collector may have an output of 1.5 V, and the boost converter 132 may boost that voltage to approximately 4.5 V. Other voltages may be used in various embodiments.

An indicator 134 may be coupled to the solar collector 130 and boost converter 132. Indicator 134 may have a light, such as a light emitting diode, that indicates whether the solar collector 130 is operational. A set of light may be used to indicate operating efficiency in further embodiments. A multimeter may be used for indicator 134 if desired.

In one embodiment, module 110 also includes a rechargeable battery 138, and a controller 140 for controlling the charging and discharging of the rechargeable battery 138. The Controller 140 may be coupled to the power collection rail 122 to receive power from one or more modules having solar collectors, and provide a battery charge voltage on a line 142 to battery 138. Battery output voltage may also be provided on a line 144 back to the controller 140 for distribution at a desired voltage on power management rail 126 for use by devices in one or more further modules. In one embodiment, the battery operates as a voltage regulator to provide a fairly regulated DC voltage for use on the power management rail 126. Additional conditioning and adjustment of the voltage on power management rail 126 may be provided by controller 140 in further embodiments.

A second module 112, also includes a solar collector 148, boost converter 150 and indicator 152 in one embodiment. The solar collector 148 is coupled to the power collection rail 122 optionally via the boost converter to provide current, which may be stored in the battery 138 or used by various devices coupled to the power distributor 120. A device 154 may also be included in second module 112, and is coupled to the power management rail 126 in one embodiment, such as through a converter 156 to convert the power management rail 126 voltage to a voltage suitable for device 154. Device 154 may be integrated with the solar collector 148 in one embodiment, or may be separate from it, but contain suitable connectors for properly connecting the respective rails of power distributor 120.

A third module 114 contains a solar collector 160, boost converter 162 and indicator 164 in one embodiment. The solar collector 160 is coupled to the power collection rail 122 optionally via the boost converter 162 to provide current, which may be stored in the battery 138 or used by various devices coupled to the power distributor 120.

A fourth module 116 contains a stand alone device 168 coupled to power management rail 126 optionally via a converter 170. It contains a connector that ensures a proper connection to the power distributor 120, such as a keyed connector that ensures it is coupled to the power management rail 126 to draw power from the batter 138 and solar collectors coupled to the power distributor 120. Various components of each of the modules are also coupled to the common ground rail 124 to complete proper electrical contact to the power distributor 120. Each connector for the modules may be keyed to ensure proper connection of the components in each module to proper rails of the power distributor.

In one embodiment, power distributor 120 is formed in the shape of a track, similar to tracks used in AC track lighting systems. The modules may be plugged into the power distributor 120 at any point along its track, and has connectors designed to ensure proper electrical connection of the various components in the modules. While only four modules are show coupled to the power distributor 120, in further embodiments, many more of various kinds of modules may be attached. The power distributor may for example be routed around a building, such as a business or home, or outdoors. Devices may be integrated with the solar collector and other components in the modules, or may be separate from them in various embodiments. They may be implemented as PCB cards or individual PCBs. Typical devices that may be incorporated into modules include, but are not limited to illumination devices, communication devices, sensors, wireless devices, routers, entertainment devices, speakers, cameras, data collection devices and more. In further embodiments, a module may also contain an inverter, for powering AC devices, or even feeding power back into a utility power grid.

FIG. 2 is a block schematic diagram representation of a module 200 for attachment to the distribution system 100 of FIG. 1. Module 200 in one example includes a solar cell 210, supported by a substrate 220. Solar cell 210 in various embodiments may be any type of solar based power generator. The substrate 220 serves as a base for the solar cell 210. It may be formed of a variety of materials that provide structure for the solar cell 210, including for example, plastic, wood, metal, glass, etc. A module base 230 may be formed proximate the substrate 220 and derive support therefrom in one embodiment. The base 230 contains wiring, battery packs, circuitry for implementing module components, optional integrated devices, and a connector 240 for coupling to the power distributor 120.

In one embodiment, a superstrate 250 may be provided over the solar cell 210 to provide a desired aesthetic to the module. Given the increase in solar power conversion ratios, the superstrate 250 may be designed more for a desired appearance than for optimal light energy transmission to the solar cell 210.

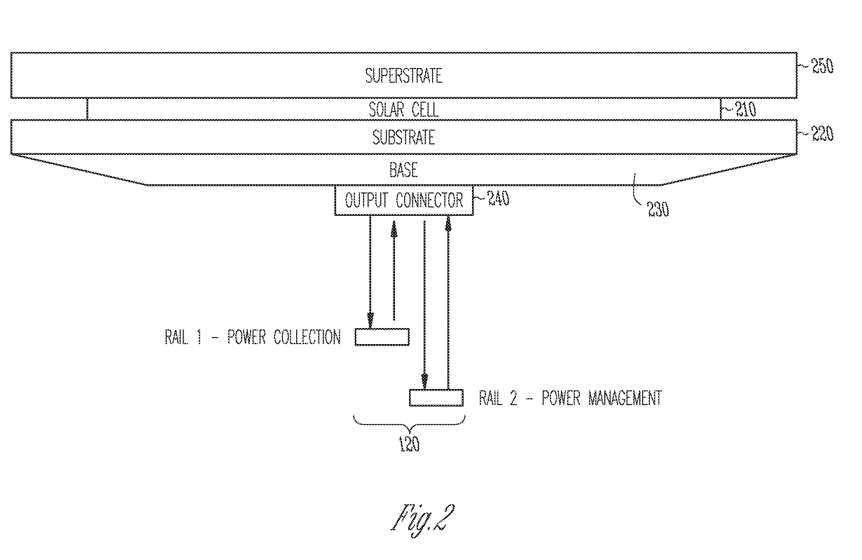

FIG. 3 is a photograph of example modules 310, 315, 320 plugged into a power distribution track 330. In one embodiment, modules 310 and 315 are DC powered illumination devices, such as lights.

Module 320 is a solar collector in an approximately 8×10 inch form, with a superstrate that provides the ability to create an aesthetically pleasing look such that the solar collector does not appear to look like a solar collector. While the term aesthetically pleasing is used, it is meant to encompass the ability to provide a broad range of looks to the solar collector. In one embodiment, the superstrate may formed of a 0.015 inch or thicker sheet of normally opaque material, such as mica or other stone, which becomes translucent when sliced very thin. For some materials, thinner sheets may be used. The thin sheet of material may be heated or laminated onto the solar cell without significantly adversely affecting the energy conversion efficiency of solar cell. Many different materials may be used, including synthetic materials used for kitchen countertops in various embodiments to provide significant design freedom to create looks for every taste.

Each of the modules has an adapter as illustrated at 340 for use in physically and electrically coupling to the power distribution track. As previously indicated, such a connector may be similar to those used for AC track lighting, but in some embodiments, should be designed such that they may not be used with current AC track lighting to avoid confusion. Further, adapter 340 may couple with track 330 in a manner such that proper electrical connections are always made, and solar collectors are coupled to the power collection rail, while devices and devices integrated with solar collectors are coupled to the power management rail of the track 330.

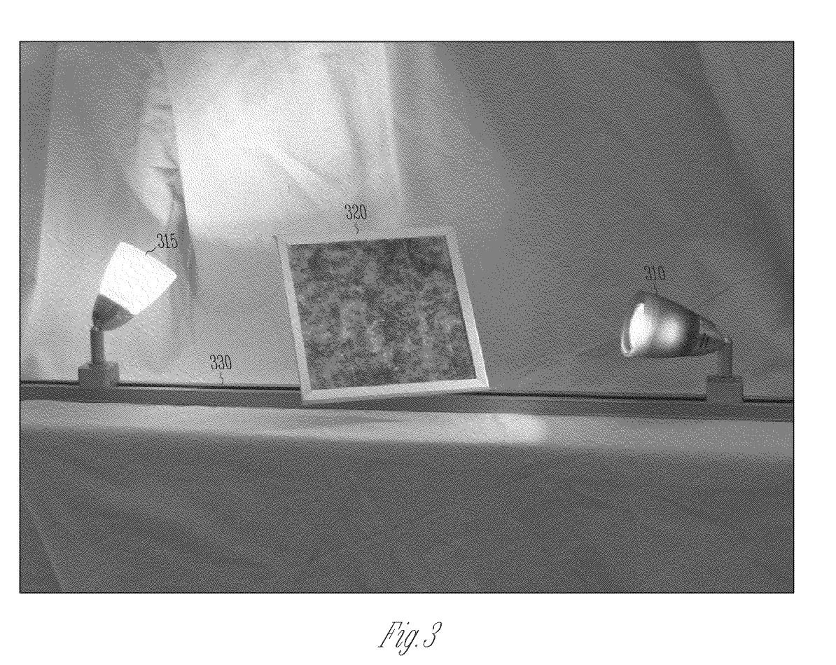

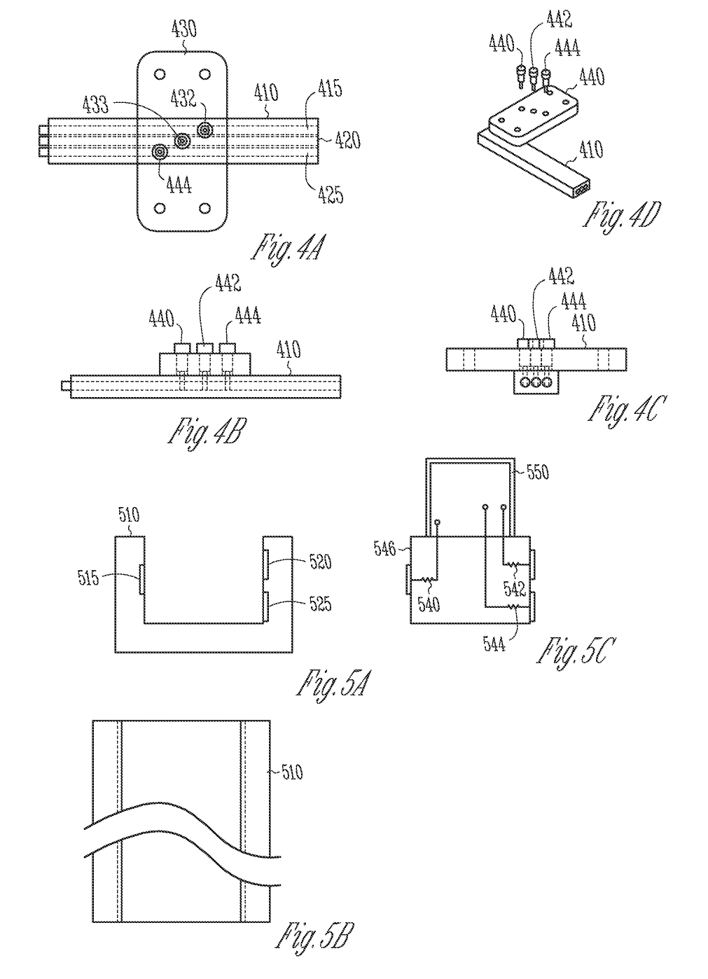

FIGS. 4A, 4B, 4C and 4D illustrate various cross section views and a perspective view of one embodiment for providing electrical contact to the rails of an example power distribution track 410. Track 410 in one embodiment comprises an insulated set of rails 415, 420, 425 in a flat rectangular insulated wiring form, with the rails disposed side by side in the insulated wiring form. The rails correspond to the common, power collection and power distribution rails previously described. A connector 430 is formed with pin holes 432, 433 434 formed in staggered fashion in one embodiment to line up with the rails 415, 420, 425 and facilitate insertion of contact pins 440, 442, 444 through the holes, penetrating the insulation and making electrical contact with the rails in a known manner. The connector in one embodiment is formed of insulating rigid plastic, and may have a groove to provide a self aligning function with the wiring form such that the holes properly line up with the desired rails, providing consistent contact with the proper rails regardless of where they contact the wiring form. Some directional indications may be provided on the wiring form and contact in order to ensure proper orientation and connection to the tracks.

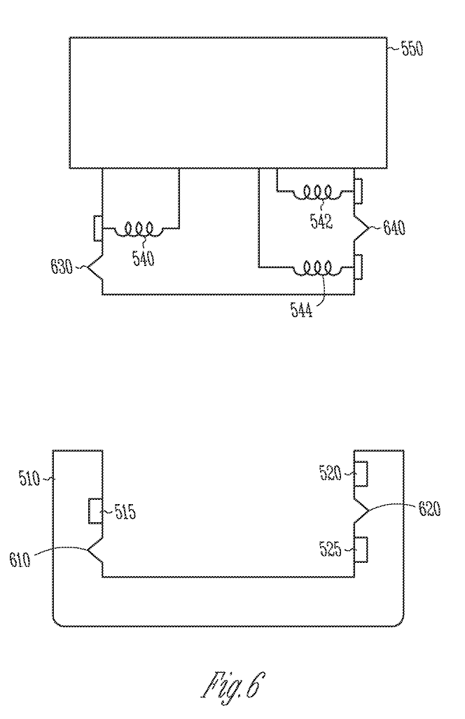

FIGS. 5A, 5B and 5C illustrate various cross section schematic views of an alternative electrical connection to a track 510 having a common ground rail 515, power collection rail 520 and power management rail 525. In this embodiment, the track 510 is formed in a “U” shape, with the rails disposed on sides of the “U”. As seen in FIG. 5B, the track may run as long as desired, consistent with the gage or conductive properties of the rails within the track. In further embodiments, tracks may be extended for as long a distance as desired, and other tracks may be coupled to a track to extend in different directions. Many different types of modules may be connected on one track or different tracks extending from the track. For example, a track may extend to a position where light is available, and one or more modules containing solar collectors. Further rails may extend to places where it is desired to have lighting, or parts of a sound system, or wireless router, etc. Many different types of modules may be plugged into the tracks in various locations to either provide power, use power, or both.

FIG. 5C illustrates electrical connections made to the rails via spring loaded contacts 540, 542, 544 in a connector body 546. The spring loaded contacts 540, 542 and 544 may be appropriately connected to various components in a module 550 when body 546 is inserted into the track 510. In one embodiment, the rails may be recessed slightly into the sides of the track 510 such that the spring loaded contacts 540, 542, 544 provide a retentive force. This retentive force may provide physical support for module 550. In further embodiments, detents may be cut into the rails to provide a larger retentive force.

In one embodiment, two connectors may be formed side by side, or at least partially orthogonal to each other and electrically connected to facilitate coupling of two tracks together to provide further modularity of the power distribution system. The connectors may be physically connected at a desired angle, or may be coupled by a flexible connector to allow a second track to run in any direction desired from a first track. In still further embodiments, the tracks may curve such that they need not run in a straight line.

In still further embodiments, additional slots may be formed in the “U” shaped track as indicated at 610 and 620 in FIG. 6, with mating protrusions 630, 640 formed on a portion of module connector body 546 engaging the “U” shaped track to provide physical retentive force separate from or in addition to the electrical connections to the rails, as indicated block diagram form in FIG. 6. In one embodiment, the slots 610, 620 and protrusions 630, 640 are offset from the rails and contacts, and are formed at different depths in the track 510. This may help insure insertion of the connector in the proper orientation. Further keying mechanisms may be used, such as the sides of the track and connectors having different lengths such that the connector cannot make electrical contact unless attached in the correct direction. Still further keying protrusions may match further keying slots that line up only when the connector is being inserted correctly into the track.

In still further embodiments, the protrusions and keying protrusions may be on the track, with corresponding slots and keying slots on the connector. The sides of the track may flex away from the connector to allow insertion and removal of the connector with a desired amount of force. In still further embodiments, further retentive force may be provided by the use of screws or other mechanical fasteners between the tracks and connectors, and many different shapes of tracks, rails, connectors, etc., may be used.

1. A system comprising:
a power distributor having a power collection rail and a power management rail disposed within a track;
at first module having a solar collector, wherein the module is adapted to couple to the track and electrically connect to the power collection rail;
a rechargeable battery for providing direct current (DC) power to the power management rail; and
a controller, coupled to the battery and to the track that receives power from the power collection rail to recharge the battery.

2. The system of claim 1 wherein the battery and controller are included within the first module.

3. The system of claim 1 and further comprising a second module that includes a solar collector and integrated device, wherein the solar collector is coupled to the power collection rail, and the device is coupled to the power management rail.

4. The system of claim 1 and further comprising a third module including a stand alone device coupled to the power management rail.

5. The system of claim 4 wherein the stand alone device includes a boost converter that converts a DC voltage on the power management rail to a desired DC voltage for operation of the device.

6. The system of claim 5 wherein the device is a wireless communication device.

7. The system of claim 5 wherein the device is a DC illumination device.

8. The system of claim 1 wherein the first module further comprises a boost converter coupled to the solar collector, and an indicator for indicating an operable state of the solar collector.

9. The system of claim 1 wherein the track further comprises a common ground rail.

10. The system of claim 1 wherein the first module has a connector adapted to plug into the track to provide proper electrical connections and physical support for the first module.

11. The system of claim 10 wherein the connector is keyed to plug into the track in only one direction.

12. The system of claim 1 and further comprising a second track coupled to the first track, wherein the second track has a power collection rail and a power management rail disposed within the track and electrically coupled to corresponding rails in the track.

13. A module comprising:
a solar collector;
a rechargeable battery;
a controller; and
a connector for coupling to a power collection and distribution track having a power collection rail and a power distribution rail, wherein the connector is adapted to electrically couple the solar collector to the power collection rail and couple the rechargeable battery to the power distribution rail.

14. The module of claim 13 wherein the connector provides physical support for the module when coupled to the track.

15. A module comprising:
a solar collector;
a device integrated with the solar collector; and
a connector for coupling to a power collection and distribution track having a power collection rail and a power distribution rail, wherein the connector is adapted to electrically couple the solar collector to the power collection rail and couple the integrated device to the power distribution rail.

16. The module of claim 15 wherein the connector provides physical support for the module when coupled to the track.

17. A module comprising:
a solar collector; and
a keyed connector for coupling to a power collection and distribution track having a power collection rail and a power distribution rail, wherein the connector is adapted to electrically couple the solar collector to the power collection rail.

18. The module of claim 17 and further comprising
a boost converter coupled to the solar collector; and
an indicator for indicating an operable state of the solar collector.

19. The module of claim 17 wherein the solar collector comprises:
a solar cell;
a substrate supporting the solar cell; and
a superstrate coupled to the solar cell to alter the appearance of the solar cell.

20. The module of claim 19 wherein the superstrate comprises a thin, partially transparent layer of an opaque material.

21. The module of claim 20 wherein the superstrate comprises a thin layer of mica bonded to the solar cell.

22. A method comprising:
plugging a first module into a power collection and distribution track having a power collection rail and a power distribution rail disposed within a track, wherein the first module has a solar collector, controller and rechargeable battery and is adapted to couple to the track and electrically connect the solar collector to the power collection rail and electrically connect the rechargeable battery to provide direct current (DC) power to the power management rail such that the controller receives power from the power collection rail to recharge the battery.

23. The method of claim 22 and further comprising plugging a second module into the track, wherein the second module includes a solar collector and integrated device, wherein the solar collector is coupled to the power collection rail, and the device is coupled to the power management rail.

24. The method of claim 22 and further comprising plugging a third module into the track, wherein the third module includes a stand alone device coupled to the power management rail.
